(19) United States
(12) Patent Application Publication
(10) Pub. No.: US 2025/0185127 A1
(43) Pub. Date: Jun. 5, 2025

(54) DUAL-FREQUENCY MlCROWAVE ANTENNA AND SOLID STATE DUAL-FREQUENCY MICROW AVE DRYING AND HEATING APPARATUS

(71) Applicant: FRESHSEAL LIMITED, West Midlands (GB)

(72) Inventors: Georgios VANEZI, Telford (GB); Vasos VANEZI, Telford (GB); Neema SEDIGHI, Telford (GB); Malik Ehsan EJAZ, Lincoln (GB); Oonagh MCNERNEY, Sant Esteve Sesrovires (ES); Alejandro Alberto Roslaes LAVIELLE, Coma-Ruga (ES)

(21) Appl. No.: 18/837,549

(22) PCT Filed: Feb. 10, 2023
(86) PCT No.: PCT/IB2023/051215

§ 371 Date: Aug. 9, 2024

(30) Foreign Application Priority Data
Feb. 16, 2022 (GB) 2202076.2
Feb. 16, 2022 (GB) 2202077.0

(51) Int. Cl. H05B 6/72; H05B 6/64; H05B 6/80

(52) U.S. Cl. CPC H05B 6/72; H05B 6/6447; H05B 6/80; H05B 2206/046

(57) ABSTRACT

An antenna for emitting microwave radiation into a cavity, and configured to emit microwave within a first frequency range of 400-500 MHz and a second frequency range of 2.4-2.5 wherein the antenna comprises a cylindrical portion 101, wherein the length of the cylindrical portion is within a range of −8% and +14% of 119 mm, and wherein the outer diameter of the cylindrical portion is within a range of −8% and +14% of 60 mm; and a frustoconical portion contiguous with the cylindrical portion, wherein the length of the frustoconical portion is within a range of −8% and +14% of 80 mm, wherein the outer diameter of the frustoconical portion tapers from a diameter within a range of −8% and +14% of 60 mm to a diameter within a range of −8% and +14% of 20 mm. Apparatus and method for the processing (drying and/or cooking) of foodstuffs and other materials using dual frequency, microwave radiation utilising solid-state power generators. The apparatus uses both an antenna and a waveguide for transmitting microwave radiation to a processing chamber. A first microwave generator generates microwave radiation having a first frequency, wherein the first frequency is substantially between 2.4 and 2.5 GHz and a second microwave generator generates microwave radiation at a second frequency, wherein the second frequency is substantially between 400-500 MHz. A microwave waveguide disposed in or at the chamber is configured to emit the microwave radiation from the first microwave generator into the chamber and an antenna disposed in or at the chamber is configured to emit the microwave radiation from the second microwave generator into the chamber.

### TECHNICAL FIELD

This invention relates to dual-frequency microwave antenna primarily but not exclusively for use in microwave apparatus for drying materials or cooking foodstuffs.

### BACKGROUND TO THE INVENTION

Microwave heating apparatuses (commonly referred to as ‘microwave ovens’) are regularly used for the processing of materials, for example, foodstuffs. Microwave ovens are used in large scale factories and smaller commercial premises such as restaurants, as well as households. A common use for microwave ovens is in the heating and drying of foods and other materials.

Drying and dehydrating is of particular importance to the food industry as dried food typically has a longer storage life than undried food. By removing water from food samples, microbial growth is inhibited, allowing for food to be stored for longer periods. Drying may be advantageous for certain foodstuffs where it is not practical or desirable to use other processing techniques such as freezing or canning.

Existing microwave heating apparatuses generally use waveguides to emit radiation into a heating chamber. US 2019/0059133 A1 discloses an electronic oven that comprises a control system to adjust the distribution of the application of energy in the heating chamber and uses 2.45 GHz and 915 MHz microwave radiation, emitted via ‘injection ports and waveguides. Though the penetration depth of 915 MHz is greater than 2.45 GHz, it is still only approximately 100 mm. This limits the efficiency of the cooking and drying process, particularly for larger product samples.

The present invention aims to eliminate, or at least mitigate, the drawbacks of existing microwave heating apparatuses.

### SUMMARY OF THE INVENTION

According to a first aspect of the invention, there is provided a monopole antenna for use in a microwave processing apparatus, wherein the monopole antenna is configured to radiate microwaves at a first frequency range of 400-500 MHz and a second frequency range of 2.4-2.5 GHz. The first frequency range may optionally be 420-450 MHz, and may be 433.05-434.792 MHz.

Such a dual-frequency antenna has applications in drying and cooking. It can take the place of much bulkier waveguides, making equipment for microwave drying and cooking realistic in size for commercial, restaurants, and household applications.

The most common form of microwave generation—magnetrons—are limited to a narrow bandwidth and, consequently, fixed-frequency operation. This both limits the frequencies that can be used and the control of the electromagnetic field that can be achieved, with the single frequency microwaves typically resulting in either an uncontrolled multimode field or a fixed standing wave field. Nonetheless, magnetrons are still widely used due to their low production cost.

The present invention utilises solid state microwave sources, which are controlled by an AI (artificial intelligent) based algorithm to manage the electric field and applied power. This feature is not available in magnetron-based systems.

Power couplers used in most contemporary microwaves are general waveguide type couplers. Waveguides are commonly used as they limit the wave propagation to one dimension, so that, under ideal conditions, power does not decrease with distance from the source, increasing the efficiency of communication. A feature of waveguides is the range of frequencies that the waveguide can operate over, which is defined by the waveguide's boundary conditions. The lowest couplable frequency (the cut-off frequency) is equal to the fundamental mode of the waveguide. The widely used WR340 waveguide operates at 2.1-3 GHz for example, making it suitable for the higher frequency of 2.4-2.5 GHz. However, waveguides for 400-500 MHz are often not feasible. The WR2300 waveguide (which operates at 350-500 MHz) has dimensions of 532×590×298 mm (L×W×H). Such a waveguide is impractical for use in a drying or cooking system due to its large size and high cost.

The antenna of the invention is a dual-frequency (dual-band) antenna that is capable of emitting microwaves in the 400-500 MHz and the 2.4-2.5 MHz bands. This makes the antenna suitable for microwave processing applications that make use of a high and low microwave frequency, for example, processing of foods to heat the surface and interior of the food samples.

Regulations specify that radiation outside ISM bands should be at a level that it does not harm radio or naval communication. Although the ISM band of 433.05-434.79 was used in the simulations discussed below, use of frequencies outside the ISM bands are possible because the microwave ovens (i.e. the processing cavity/chamber) are vacuum and EM sealed. As such, radiation cannot escape the chamber.

The antenna comprises a cylindrical portion, wherein the length of the cylindrical portion may be within a range of −8% and +14% of 119 mm, and wherein the outer diameter of the cylindrical portion may be within a range of −8% and +14% of 60 mm. The antenna also comprises a frustoconical portion contiguous with the cylindrical portion, wherein the length of the frustoconical portion may be within a range of −8% and +14% of 80 mm, wherein the outer diameter of the frustoconical portion may taper from a diameter within a range of −8% and +14% of 60 mm to a diameter within a range of −8% and +14% of 20 mm. A further cylindrical portion having a length within a range of −8% and +14% of 20 mm and outer diameter within a range of −8% and +14% of 26 mm connects the antenna to the coaxial connector.

The antenna may comprise a connector configured for connecting the antenna to a microwave supply source. The connector may be a coaxial connector such as a DIN connector, for example, a 7/16 inch (11.1 mm) screw-on connector.

The cylindrical connecting portion may be a separate component to the frustoconical portion. By having a limited number of separate components, the antenna is easier to manufacture and lower cost than other designs.

According to a second aspect of the invention, there is provided a microwave processing apparatus comprising: a processing chamber; and an antenna according to the first aspect of the invention, configured to radiate microwaves into the chamber.

The microwave processing apparatus may further comprise another microwave radiator for radiating microwaves into the chamber, wherein the other radiator is separated from the antenna by an odd multiple of half wavelengths (-6.12 cm) of 2.45 GHz.

The other microwave radiator may be a waveguide. The microwave processing apparatus may further comprise a second waveguide or multiple waveguides for radiating microwave energy into the chamber. The waveguides used in the apparatus may be commercially available such as WR340 waveguides.

The processing chamber defines a cavity, and wherein the length, width and height of the cavity are preferably approximately 70 cm×70 cm×80 cm.

The antenna may be matched with the chamber to be resonant in two frequency bands of 400-500 MHz and 2400-2500 MHz.

The antenna may be configured so that the chamber behaves as a single-mode cavity when the antenna radiates microwaves in the 400-500 MHz frequency range.

The antenna and two waveguides may be configured so that the chamber behaves as a broadband, multimode cavity with a uniform field distribution when the antenna and two waveguides radiate microwaves in the 2400-2500 MHz frequency range.

Preferably, the antenna is separated from a first vertical side wall of a processing chamber by at least 15 cm to a maximum of 21 cm, whereas from a second side wall adjacent to the first side wall by at least 17 cm to a maximum of 25 cm. The antenna is preferably separated from the first and second side walls by approximately one quarter of a wavelength (˜17 cm) of 400-500 MHz, to achieve greater than 90% of radiation efficiency.

A further aspect of the invention is the use of a customised dual-band monopole antenna instead of a WR2300 waveguide in a microwave heating apparatus. Two different types of radiators are preferably used—a monopole antenna and one or more waveguides to excite the cavity. Preferably, the antenna is customised, low profile, cost-efficient and dual-band to excite the cavity for two ISM band frequencies (433.05-434.790 MHz and 2400-2500 MHz). Furthermore, the excitation frequencies are more than two octaves apart. One octave happens at the second harmonic (2fo) of the fundamental frequency, whereas the second octave happens at 2×2fo e.g. if fo is 433 MHz then the first octave will happen at 866 MHz and the second octave would be 1732 MHz.

According to a third aspect of the invention, there is provided a microwave processing apparatus comprising a cavity and a dual band antenna configured to emit microwave radiation at 400-500 MHz or 2.4-2.5 GHz, and at least one waveguide configured to emit microwave radiation at 2.4-2.5 GHz, wherein the antenna and the at least one waveguide are separated by an odd multiple of half wavelengths of 2.45 GHz microwave radiation.

A further aspect of the invention is irradiating water contents within a load in a cavity with three solid-state driven radiators (2×WR340, 1× antenna) at the same time (2.4-2.5 GHz).

Cavity excitation within 400-500 MHz band is by an antenna. The cavity is designed as a single mode cavity TE101 at 400-500 MHz and multimode from 2.4-2.5 GHz without manually changing the solid-state sources. A diplexer has been used at the common antenna port to connect 400-500 MHz as well as 2.4-2.5 GHz radiators to the antenna, allowing the cavity to switch state from single mode (TE101 at 400-500 MHz) to multimode (2.4-2.5 GHz).

Moreover, the cavity is scalable in the sense that increasing the distance between the WR340 waveguides in an odd multiple of the half wavelength (-6.12 cm) at design frequency (2.4-2.5 GHz) will keep the cavity as a broadband resonating chamber.

Although discussed here in relation to the drying and cooking of food, these apparatuses and techniques are also useful for the processing of materials in other industries.

### BRIEF DESCRIPTION OF THE DRAWINGS

Embodiments of the invention will be described by way of example, with reference to the accompanying drawings, in which:

FIGS. 1a to 1e show perspective views, side view and bottom view of an optimised antenna according to an embodiment of the invention;

FIG. 2 shows an S11 simulation in respect of an antenna according to the present invention;

FIG. 3 is a diagram of a microwave processing apparatus according to an embodiment of the present invention;

FIG. 4 is a three-dimensional diagram of a microwave processing apparatus according to an embodiment of the invention;

FIG. 5 is a top-down view of the microwave processing apparatus of FIG. 4;

FIGS. 6a and 6b are representations of a simulation of the electric field applied to a load in a microwave processing apparatus when operated in the 400-500 MHz frequency band;

FIGS. 7a to 7c are representations of a simulation of the electric field applied to a load in the microwave processing apparatus when operated in the 2.4-2.5 GHz frequency band;

FIG. 8 is a graph of the S11 response of an antenna and waveguides when the microwave processing apparatus is operated in the 2.4-2.5 MHz frequency band.

### DETAILED DESCRIPTION

Aspects of the present invention concern means for processing organic matter to different frequencies of microwave radiation. In particular, aspects of the present invention provide means for processing organic matter with 400-500 MHz radiation as well as 2.45 GHz radiation. Since 400-500 MHz radiation has a penetration depth greater than the penetration depth of 2.45 GHz radiation, the provision of 400-500 MHz radiation as well as 2.45 GHz radiation allows for more efficient and flexible processing of organic matter.

It is known to use waveguides for radiating 2.4-2.5 GHz and 915 MHz microwaves. Although a waveguide can provide 400-500 MHz radiation, waveguides for this frequency band are large, bulky and expensive and as such are generally not suitable for smaller microwave processing ovens or other apparatus for this band of frequencies. For example, when used in a microwave processing apparatus, and arranged to emit radiation into a processing cavity, the return loss performance of a WR2300 waveguide is very poor which means it needs to be moved around to find a better location. However, the large size of the waveguide adaptor required to transform a coaxial output of an (solid state power generator) SSPG source limits its manoeuvrability.

Accordingly, use of an antenna for emitting 400-500 MHz is deemed more practical. A simple monopole (‘rod’) antenna (196 mm in length and extending into cavity by one quarter wavelength at 433 MHz, screw thread 30 mm, inner screw thread diameter 4.8 mm, outer diameter 12 mm) connected directly to DIN 7/16 coaxial connector and located in the centre (i.e. extending centrally from the top horizontal wall of a processing cavity of a microwave processing apparatus) was tested to provide 400-500 MHz. However, the EM field produced in the cavity is uneven, and provides a poor S11 (reflected power) response. When the position of the antenna is moved to be one quarter of the wavelength of 433 MHz away from a vertical wall, the S11 parameter is even worse. Thus it is clear that moving antenna away from centre has made radiation and return loss S11 performance worse. Nevertheless, having the antenna (extending down from the top horizontal wall) laterally positioned closer to one or two vertical walls of a processing cavity, rather extending centrally from the top horizontal wall is desirable to improve the cavity space utilisation.

Following these tests, the geometry of a simple monopole antenna was varied and the S11 response determined. An antenna with a frustoconical section, centrally located (laterally), extending into cavity from the top horizontal wall of a processing cavity, with loading at radiating end with 7 mm connecting part (7 mm diameter to match connector pin diameter) to DIN 7/16 was tested. This produced an improved S11 response. The same antenna placed one quarter wavelength of 433 MHz from two adjacent vertical cavity walls was also tested, but this produced a poorer S11 response than when in the centre. Additionally, the same antenna but with a 12 mm diameter connecting part was tested at a central position (which produced a good S11 response) and one quarter wavelength from two adjacent vertical walls (which produced a very poor S11 response). The same 12 mm diameter antenna placed 10 cm away from two adjacent vertical walls provided an even poorer S11 response.

The inventors of the present invention developed a customised antenna 100 which provides improved S11 and radiation performance whilst allowing for efficient cavity space utilisation.

The antenna provided is a dual-frequency antenna that can be operated efficiently in both the 400-500 MHz band and the 2.4-2.5 GHz band. This makes the antenna 100 suitable for use in microwave processing apparatuses that are designed to use a high and low frequency to process food samples. The use of a higher and lower frequency is beneficial as it allows for penetration of microwave radiation to different depths in the sample, which may result in more desirable or uniform heating of the sample.

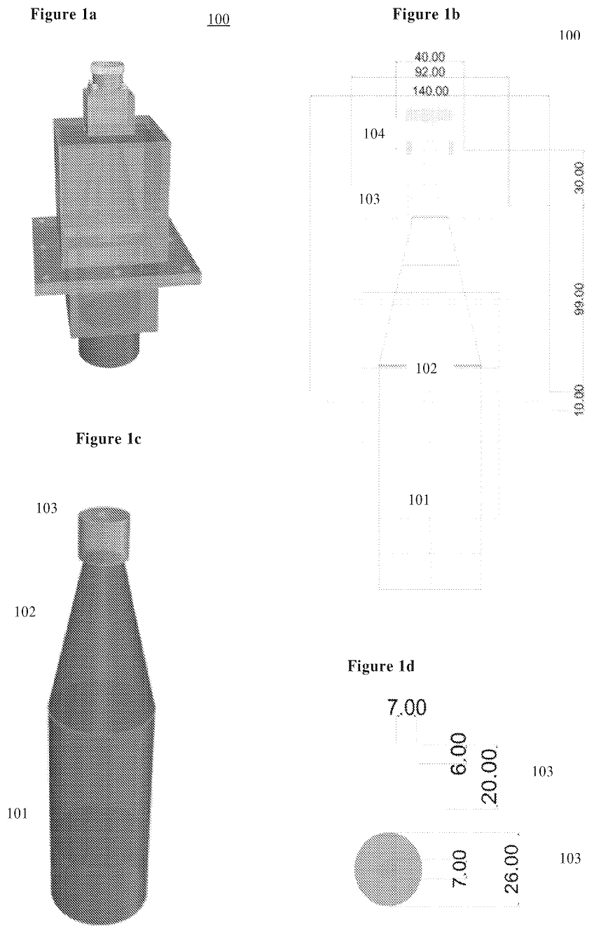

Referring to FIGS. 1a to 1e, antenna 100 comprises a lower antenna region 101. The lower antenna region 101 is cylindrical with a diameter of approximately 6 cm and a length of 119.33 mm (approximately 12.3 cm). The antenna 100 comprises an upper antenna region 103. The upper antenna region 103 is cylindrical in shape and detachable from frustoconical section 102 which is contiguous with the lower antenna region 101, tapering from a diameter of approximately 6 cm to approximately 2 cm. As shown in FIG. 1d, upper antenna region has an outer diameter of approximately 26 mm, a height of 20 mm, an internal diameter of approximately 7 mm defining an internal cavity which extends approximately 6 mm into the main body of upper antenna region 103. The geometry of the antenna transforms, or matches, the coaxial impedance to loaded cavity impedance.

Antenna 100 also comprises a coaxial-type connector such as a DIN 7/16 inch (11.1 mm) screw-on connector adapted to attach directly onto a microwave radiation source and diplexer comprising a counterpart mating connector. Alternatively, the antenna 100 may be connected to the microwave radiation source via a coaxial cable. The connector has an inner cylinder (such as the centre pin or connector of a coaxial type connector) that may or may not protrude from the connector. The centre cylinder has a diameter of approximately 7 mm.

FIG. 1a, shows antenna 100 surrounded by dielectric shielding. The dielectric shielding is required for impedance transformation in order to improve the return loss S11.

The antenna 100 has a lower portion of dielectric material that surrounds a portion of the lower antenna region 101. A portion of the lower antenna region 101 is not surrounded by a dielectric material, so is left exposed. The exposed portion has a length of approximately 4.2 cm. The lower dielectric surround has a length of approximately 8 cm. The lower dielectric surround is in this example cubic in shape, with side lengths of approximately 8 cm (8×8×8 cm cube).

The antenna has an upper portion of dielectric material that surrounds the upper antenna region 102. The upper dielectric surround is cuboidal in shape, with a length of approximately 10 cm and a width and depth of approximately 8 cm (8×8×10 cm cuboid). The upper dielectric surround comprises a metal skin that encloses or shields the dielectric material.

In some embodiments, the lower portion and upper portion of dielectric material may be separate components. In other embodiments, the lower portion and upper portion may be parts of a common dielectric body.

The antenna has a transition region of dielectric material that surrounds the region directly above the upper antenna region 102. The transition dielectric surrounds the antenna upper portion 103. The transition dielectric surround is cuboidal in shape, with a length of approximately 3 cm and a width and depth of approximately 5 cm (5×5×3 cm cuboid). The transition dielectric surround has a metal skin that encloses or shields the dielectric material.

Lower portion 101 and frustoconical portion 102 are manufactured as a single piece. The antenna 100 is advantageous over existing antennas due to its design and use of segmented parts. The use of a lower region 101, frustoconical middle region 102, separate upper region 103 and separate shielding allows for manufacture and machining of the antenna 100 more easily than designs that are one single body, which reduces the associated manufacturing cost. The use of commercial parts and materials (such as Delrin thermoplastic) also reduces cost. The present design reduces manufacturing complexity but also uses fewer parts than other designs, improving the ease of assembly. The chosen components keep the overall size of the antenna small, while still being suitable for high power RF applications.

To ascertain the geometrical tolerances of the antenna, antenna elements were uniformly increased or decreased by a scaling factor to understand the maximum and minimum size limitation before antenna performance starts degrading. A standard performance measure for an antenna is its S11 (return loss) value, which should be at least −9.5 dB for 90% through and 10% reflected power. Based on this performance factor it was found that antenna size can be increased up to 14% (with some band limitation) of the size described with reference to FIGS. 1a to 1e and still maintain S11 performance. Up to 8% size reduction can be applied to the value of the antenna described with reference to FIGS. 1a to 1e and still maintain satisfactory S11 performance. Therefore, +14% to −8% tolerance for the antenna design described above has been found to be acceptable. Tolerances for 2.4-2.5 GHz are greater than for 400-500 MHz due to the shorter wavelength.

In a further test, when the antenna was placed 17 cm/one quarter wavelength from one vertical wall (and directly adjacent to another vertical cavity wall), the S11 response was found to be slightly poorer. When the antenna was moved 2 cm towards one wall, and the 17 cm distance was maintained from another wall, the S11 response improved. When the antenna was placed 17 cm-2 cm from one vertical wall and 17 cm+8 cm from another wall, the S11 response was very good. Thus, it has been found that, for optimal cavity excitation at 400-500 MHz, a customised antenna positioned one quarter wavelength (at 433 MHz) away from a vertical wall is the best starting point. The position of the antenna can then be adjusted to match the cavity loading.

When the antenna is placed 17 cm (λ/4) away from two walls (away from the corner) it presents −11.2 dB of S11, which means greater than 90% of power is delivered to the cavity. Furthermore, when antenna is moved further 2 cm towards one wall and 8 cm away from another, it presents −19.2 dB of S11 which means 98% power is delivered to the cavity. Accordingly, the antenna positioning maxima and minima is 17−2=15 cm and 17+8=25 cm. In other words, the antenna can be placed anywhere between 15 cm to 17 cm from one wall and between 17 cm to 25 cm from the other wall and its S11 value will be anywhere between −11.2 dB to −19.2 dB (90 to 98% power delivery). Antenna positioning also depends on cavity size and loading conditions but the limits established here are good reference points. Antenna positioning for 2.4-2.5 GHz band has wider tolerance due to the shorter wavelength.

The tests described above were conducted under 500 W, 400-500 MHz, fully loaded cavity, where the reflected power is in the region of 4-10% of the forward power. Even though the simulated S11 performance improves with increasing frequency, it was found that the antenna performs better at lower side of the band.

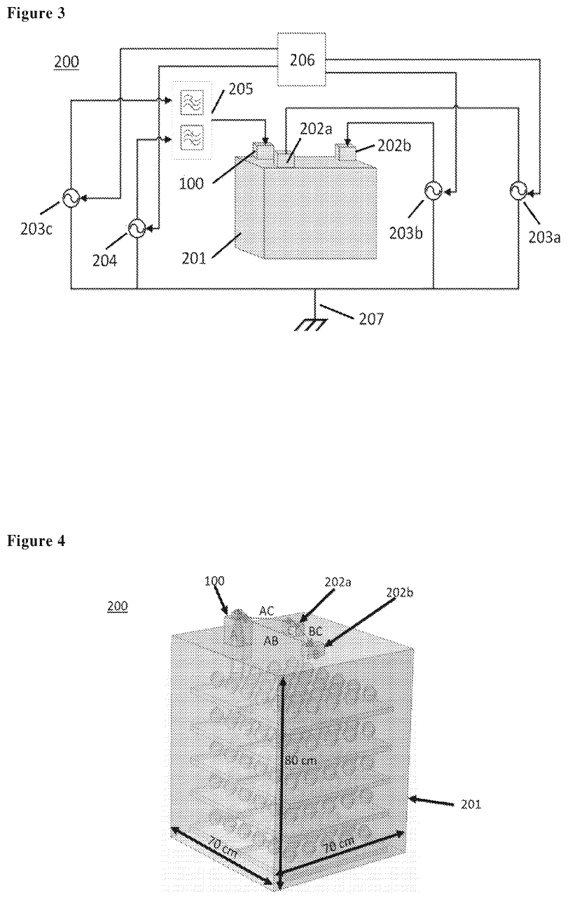

Referring to FIG. 3, an example microwave processing apparatus 200 is shown. The apparatus 200 comprises a processing chamber 201 and an antenna 100 that may be similar to the antenna described previously in FIGS. 1a to 1e. The processing chamber has a size of about 70 cm×70 cm×80 cm. Other preferred embodiments may be larger by increments of quarter wavelength of the 433 MHz frequency any dimension (or any 2 or 3 dimensions), or smaller—by quarter wavelength of the 433 MHz frequency. The dimensions of the chamber may be scaled to meet the physical needs of the user (e.g. how much space is available, the size of the food samples to be processed), and also to ensure that the chamber and power couplers act as a resonating cavity as desired. For example, a different arrangement or number of antenna or waveguides may necessitate a chamber with different dimensions to produce the desired electric field, within the restrains of the size constraints mentioned above in terms of quarter wavelength of the 433 MHz.

The size of the chamber for 2.4-2.5 GHz band does not have limitations (as long the chamber is suitable for 400-500 MHz), however, when changing the size of the chamber, the position of the WR340 waveguides may have to be re-established by the use of EM simulations.

In this example, apparatus 200 further comprises two waveguides 202a, 202b. The waveguides 202a, 202b may be WR340 or WR430 waveguides configured to operate with microwave radiation with a frequency of 2.4-2.5 GHz. The waveguides 202a, 202b are separately connected to first microwave radiation sources 203a, 203b configured to generate microwave radiation with frequencies of 2.4-2.5 GHz.

The antenna 100 is connected to a first microwave radiation source 203c, configured to generate microwave radiation with a frequency of 2.4-2.5 GHz, and also to a second microwave radiation source 204, configured to generate microwave radiation with a frequency of 400-500 MHz. The first microwave radiation sources 203a-c and second microwave radiation source 204 may be any microwave generator but are preferably solid-state power generators (SSPGs). The microwave generators and waveguides/antenna in this example are connected with coaxial cables.

The apparatus 200 comprises a diplexer 205 that is operable to select one of the microwave inputs from the first microwave radiation source 203c and second microwave power source 204 and supply this to the antenna 100. The diplexer 205 is connected to the antenna 100 with sufficient isolation (−20 dB) so that the antenna 100 is capable of radiating at both 400-500 MHz and 2.4-2.5 GHz. When one of the microwave radiation bands is selected, the other microwave radiation generator(s) may be switched off e.g. when the antenna 100 is operated to radiate at 400-500 MHz, the first microwave radiation sources 203a-c will be switched off. Likewise, when the antenna 100 and waveguides 202a-b are operated to radiate at 2.4-2.5 GHz, the second microwave radiation source 204 will be switched off.

The apparatus 200 includes a controller 206 that is configured to control the power outputs of the microwave power generators 203a-c and 204. Additional electronic connections may be included as required, such as to an earth point 207.

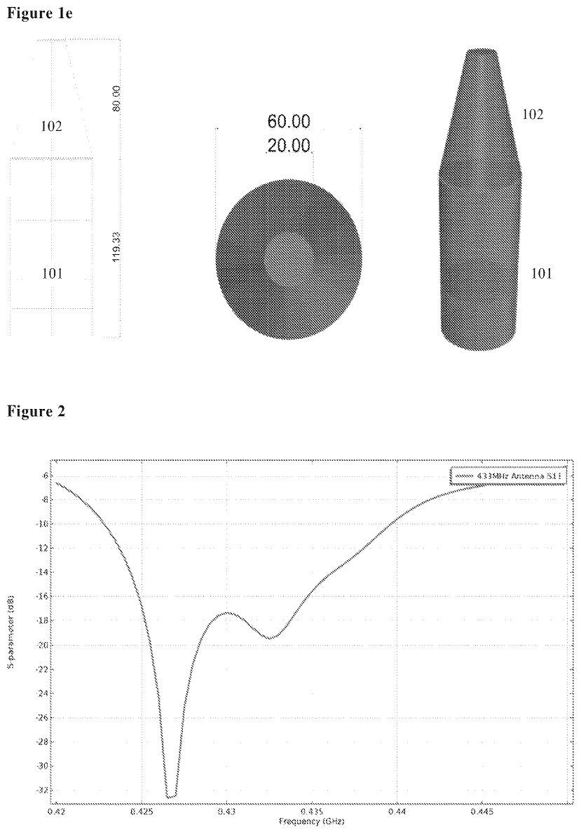

Referring to FIG. 4, the microwave processing apparatus 200 is similar to that described with reference to FIG. 3. The apparatus 200 comprises a processing chamber 201, two waveguides 202a, 202b and an antenna 100 similar to that described previously in FIGS. 1 and 2.

As will be described, the location and arrangement of the waveguides 202a, 202b and the antenna 100 have been discovered to be especially well positioned and have been tested and are preferable for chamber 201 of this example.

The waveguides 202a, 202b and the antenna 100 are separated by odd multiples of half wavelengths of 2.45 GHz microwaves. The wavelength of 2.45 GHz microwave radiation is 12.24 cm. Using separations of odd multiples of half wavelength ensures that the interference between the electromagnetic waves radiating from the waveguides 202a, 202b and antenna 100 is null such that it does not make the overall structure a reflector and the broadband nature of the resonating structure is preserved (discussed later in more detail).

In this example, the separation AB of the centres of the two waveguides 202a, 202b is five half wavelengths; the separation AC of the centre of the antenna 100 and centre of the first waveguide 202a is five half wavelengths; and the separation BC of the centre of the antenna 100 and the second waveguide 202b is also five half wavelengths. This is based on a wavelength of 2.45 GHz microwave radiation (12.24 cm).

These separations were tested and found to be preferable for chamber 201, shown in the example, with a width of approximately 70 cm, depth of 70 cm and height of 80 cm. Testing has shown that the broadband resonant behaviour and electromagnetic field uniformity is preserved when the separations are altered to different odd multiples of half wavelength. As such the separations may be increased (to say 11, 13, 15, etc half wavelengths) without affecting the resonant properties of the cavity, thereby allowing apparatus 200 to be scaled to larger units which may be suitable for industrial uses.

Chamber 201 is designed and scaled so that it acts as a well-defined single-mode cavity in the 400-500 MHz band and a multimode cavity in the 2.4-2.5 GHz band, thus allowing both frequencies to be used efficiently in the same apparatus. As discussed previously, the use of both frequencies may be beneficial in the processing of foods as both the surface and interior of the food can be heated efficiently.

The use of both an antenna 100 and at least one waveguide 202a, 202b is advantageous in creating a uniform and controllable electromagnetic field inside chamber 201. Antennas and waveguides have very different propagation patterns (being a free-space emitter and a one-dimensional propagator respectively). A combination of these two different emitters with phase and frequency controlled by an AI algorithm allows for greater control of the electromagnetic field as compared to apparatuses which only use antennas or waveguides, or a single excitation frequency. As discussed below, apparatus 200 comprising an antenna 100 and waveguides 202a, 202b provides a substantially uniform field, which allows for more even and controllable heating of materials.

In other embodiments of the invention, the greater control enabled by the use of an antenna and waveguides may be used to generate a non-uniform field, wherein different regions of the chamber experience different field densities. For example, an upper region of the chamber may have a high electric field, whereas a lower region of the chamber may have a low electric field. This may be used to process two different materials simultaneously. This phenomenon is supported by the phase and frequency sweep controlled by the AI algorithm, as mentioned previously.

In some embodiments, chamber 201 may comprise multiple shelves or guide slots wherein racks, grids, and a variety of gastronome-type containers may be secured. These shelves can be used to hold food samples during processing. The shelves may be arranged so that they experience different electromagnetic fields, enabling foodstuffs placed on different shelves to be processed differently.

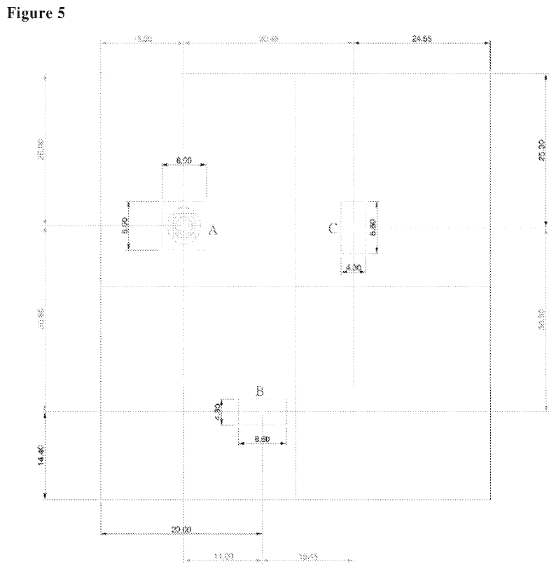

FIG. 5 shows a top-down view of apparatus 200 with the antenna 100 and waveguides 202a, 202b as described previously in FIG. 4. The waveguides used in this example are WR340 or WR430 waveguides, with a spatial footprint on the surface of the chamber of 4.318 cm by 8.636 cm. The measurements shown are in centimeters.

Referring to FIG. 2a, simulations indicate that the S11 response of the antenna 100 shows less than −10 dB return loss for a substantial portion of the 400-500 MHz frequency band when delivering the microwave energy to the chamber as described previously. This corresponds to better than 90% efficiency for the antenna 100 delivering microwave power of this frequency to the chamber. The efficiency of microwave power delivery may allow for more efficient microwave processing of products and therefore less energy usage and faster processing times.

Referring to FIG. 2b, simulations show that the microwave processing apparatus 200 described previously produces a uniform single-mode electromagnetic field. Resonating under TE101 mode (the dominant mode), the apparatus exhibits no hot spots when the antenna 100 is operated at 400-500 MHz.

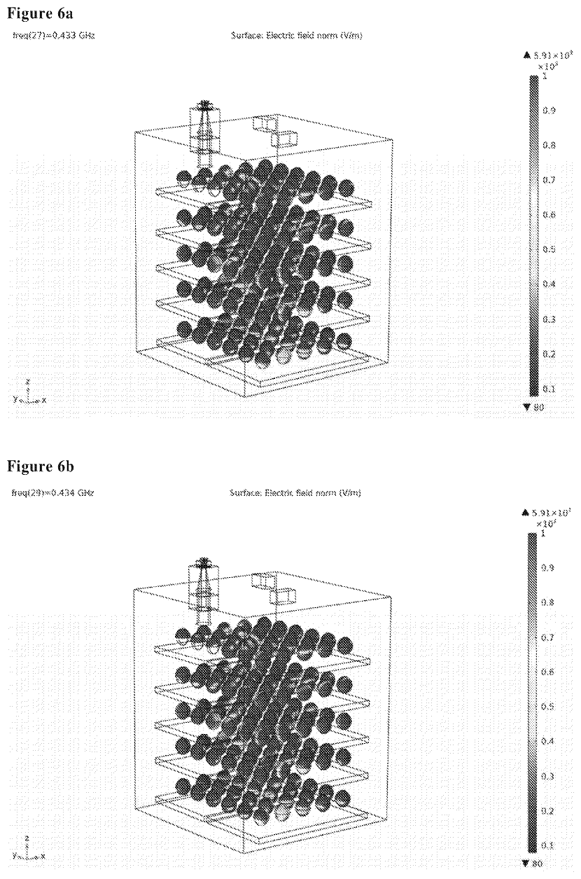

Referring to FIGS. 6a-6b simulations show that apparatus 200 exhibits a substantially similar electric field across the 400-500 MHz frequency band. FIG. 6a shows the electric field experienced by a load at 433.05 MHz, while FIG. 6b shows the electric field experienced by the same load at 434.792 MHz. The field is substantially the same for the two frequencies, due in part to the narrow bandwidth of just 1.742 MHz. This allows for consistent microwave processing across frequencies in this particular band.

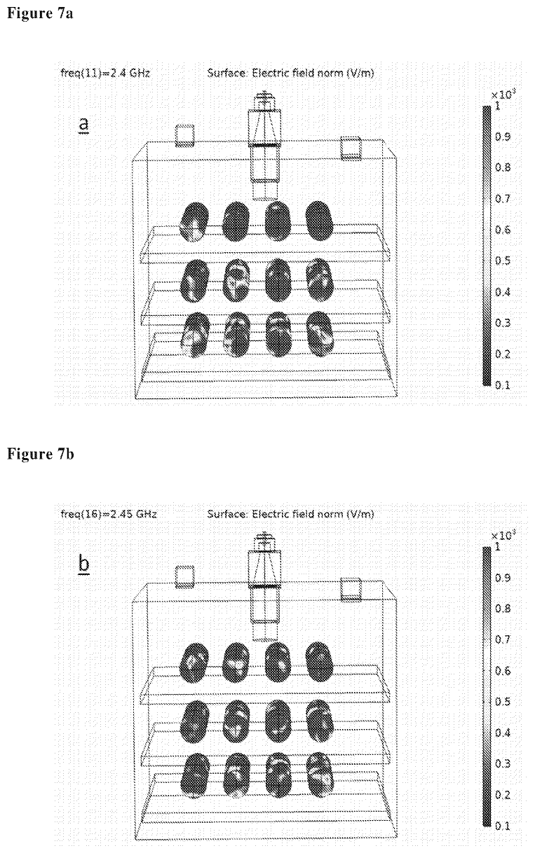

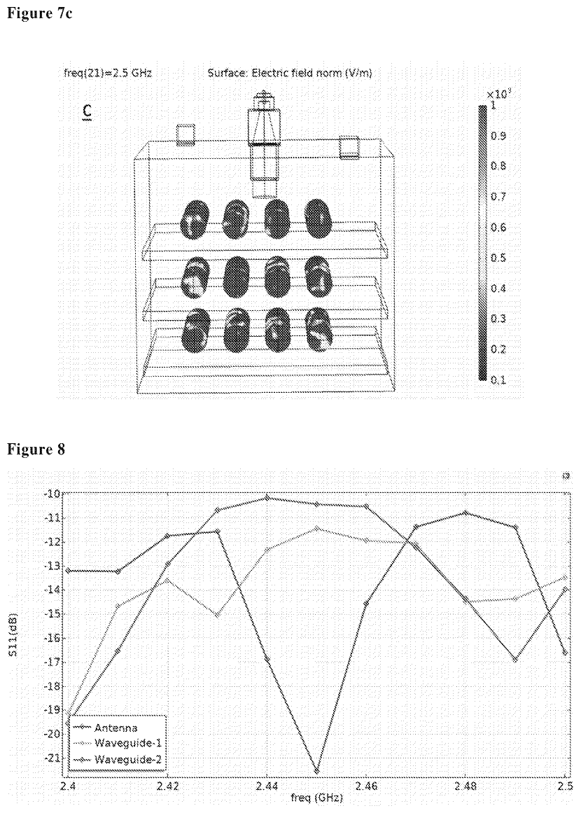

Referring to FIGS. 7a-7c, simulations show that the microwave processing apparatus 200 described previously produces a multimode excitation that resonates over the 100 MHz bandwidth of the 2.4-2.5 GHz frequency band, unlike the single-mode resonance of the 400-500 MHz band. FIGS. 7a-7c show simulations for 2.4 GHz, 2.45 GHz and 2.5 GHz respectively. The simulations show that the field is substantially uniform and similar across the frequency band. This may be beneficial as performing a frequency sweep across the 2.4-2.5 GHz band will guarantee full exposure of the load to the electric field during processing, and thus ensure a uniform heating profile. As the penetration depth of this frequency band is low, this may be used to add crispiness to the food sample being processed.

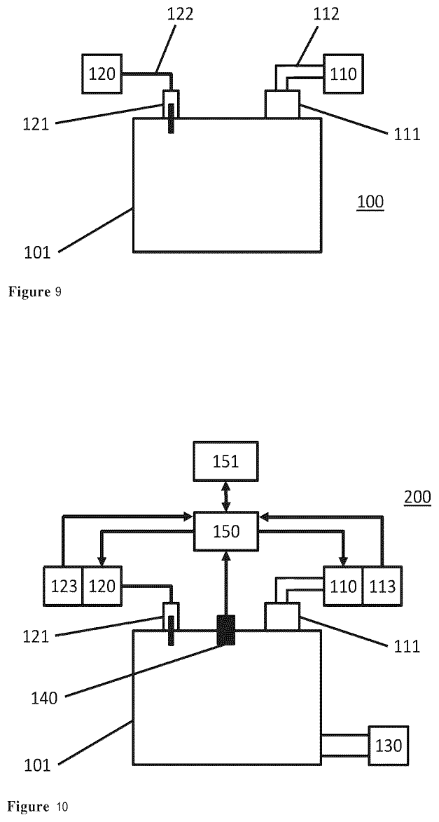

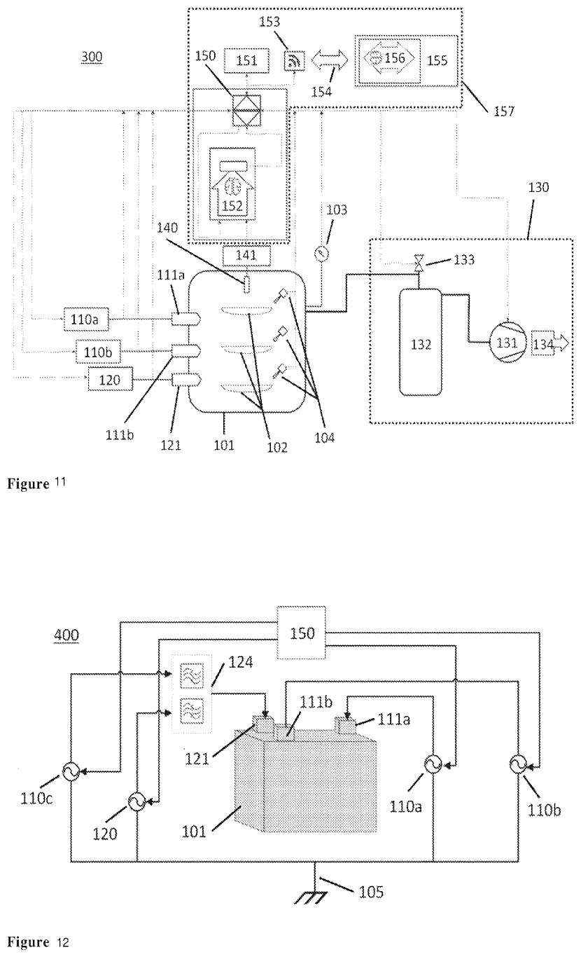

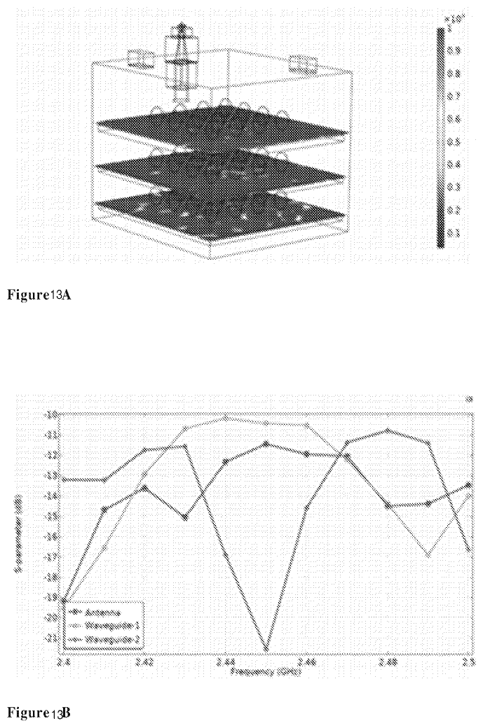

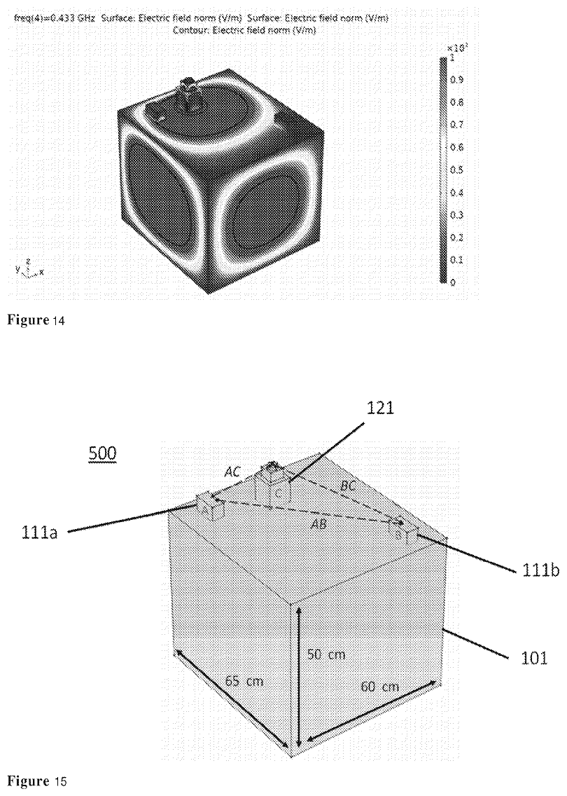

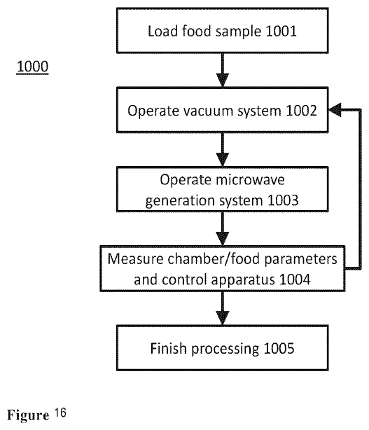

Referring to FIG. 8, simulations show that the antenna 100 and waveguides 202a, 202b all exhibit an S11 response with a return loss of less than −10 dB across the 2.4-2.5 GHz frequency band. This corresponds to better than 90% efficiency in delivering the microwave power to the chamber. The simulation shows that the antenna 100 becomes critically coupled at 2.45 GHz, where more than 99% of the microwave power is delivered to the load inside the chamber. Again, this efficiency may result in lower energy usage, operating costs, and processing times.

Although example embodiments have been described, these are not intended to limit the scope of the invention, which should be determined with reference to the accompanying claims.

Solid State Dual-Frequency Microwave Drying and Heating Apparatus within a Vacuum Environment Using NIR Analyser, AI and Machine Learning.

### Technical Field of the Invention

This invention relates to dual frequency microwave drying, cooking and heating apparatus and associated methods, primarily but not exclusively for products such as foodstuffs.

### Background to the Invention

Microwave heating apparatuses (commonly referred to as ‘microwave ovens’) are regularly used for the processing of materials, for example foodstuffs. They are used in large scale factories, smaller commercial premises such as restaurants, and domestic households. A common use for microwave ovens is in the heating and drying of foods and other materials.

Drying and dehydrating is of particular importance to the food industry as dried food typically has a longer storage life than undried food. By removing water from food samples, microbial growth is inhibited, allowing for food to be stored for longer periods of time. Drying may be advantageous for certain foodstuffs where it is not practical or desirable to use other processing techniques such as freezing or canning.

Microwave ovens are particularly suitable for vacuum-aided drying. By controlling the microwave energy (heating) and vacuum of the apparatus, efficient and effective heating, cooking and drying can be achieved.

It is a known desire to have as uniform an electromagnetic field within the chamber as possible, to achieve consistent conditions and thereby achieve even and predictable processing of the samples. If the electromagnetic field is uneven, ‘hot spots’ can be generated in the food. These are areas of particularly high field density that result from interference or resonance effects. As the material heats up in the hot spot, its dielectric properties change, causing it to absorb more microwave energy and heat up further. This may result in thermal runaway and the materially being rapidly overdried or overcooked in these hot spot areas.

Some conventional microwave heating apparatuses use more than one microwave frequency. US 2019/0059133 A1 discloses an electronic oven that comprises a control system to adjust the distribution of the application of energy in its heating chamber, and uses 2.45 GHz and 915 MHz microwave radiation, emitted via ‘injection ports’ and waveguides. The higher frequency of 2450 MHz has a more limited penetration depth than the 915 MHz frequency, but 915 MHz frequency still has limited depth compared to 400-500 MHz. The frequency of the radiation therefore limits the extent of cooking/drying within a sample volume.

The present invention aims to eliminate, or at least mitigate, drawbacks of existing microwave heating apparatuses.

### Summary of the Invention

According to a first aspect of the invention, there is provided a microwave food processing apparatus comprising: a sample processing chamber; a first microwave generator configured to generate microwave radiation at a first frequency within a range, wherein the range is 2.4-2.5 GHz; a microwave waveguide disposed in or at the chamber configured to couple the microwave radiation from the first microwave generator to the chamber; a second microwave generator configured to generate microwave radiation at a second frequency within a range, wherein the range is 400-500 MHz; an antenna disposed in or at the chamber configured to couple the microwave radiation from the second microwave generator to the chamber, wherein the apparatus preferably also comprises a controllable vacuum system operable to vary the pressure in the chamber during processing.

The sample may be food and/or any material containing water. Even though part of the operating frequency range is out of the ISM band, the apparatus is compliant with ITU Article 15 section 15.13. The first microwave generator may preferably emit radiation within the 420-450 MHz, and optionally within the range 433.05-434.79 MHz.

The most common form of microwave generation in known systems—magnetrons—are necessarily limited to a narrow bandwidth and, consequently, fixed-frequency operation. This both limits the frequencies that can be used and the control of the electromagnetic field that can be achieved, with the single frequency microwaves typically resulting in either an uncontrolled multimodal field or a fixed standing wave field. Also, magnetrons have a very short life span compared to solid state technology. Nonetheless, magnetrons are still widely used due to their low production cost.

Power couplers used in most contemporary microwaves are general waveguide type couplers. Waveguides are commonly used as they limit the wave propagation to one dimension, so that, under ideal conditions, power does not decrease with distance from the source, increasing the efficiency of energy transfer. A limiting factor of waveguides is the range of frequencies that the waveguide can operate over, which is defined by the waveguide's boundary conditions. The lowest pass band frequency (the cut-off frequency) is equal to the fundamental mode of the waveguide. The widely used WR340 waveguide operates at 2.1-3 GHz for example, making it suitable for the higher frequency 2.4-2.5 GHz microwave frequency. However, waveguides for 400-500 MHz are often not feasible. The WR2300 waveguide (which operates at 350-500 MHz) has dimensions of 266.7×533.4 mm. Such a waveguide is impractical for use on a range of chamber sizes particularly on smaller sizes.

Advantageously, the present invention circumvents the need to use two waveguides—one for the higher frequency of 2400-2500 MHz, namely WR340 or WR430 waveguides, and one for the lower frequency of 400-500 MHz, namely the WR2300 waveguide. Instead, a smaller antenna structure is used for radiating the 400-500 MHz frequencies.

433.05-434.79 MHz and 2.4-2.5 GHz are both designated industry, scientific and medical (ISM) bands that may be used in microwave ovens. The apparatus of the present invention is compliant with ITU Article 15 section 15.13 which allows operation between 400-500 MHz, and, more broadly, any frequency that is deemed suitable for the present purpose.

Use of an antenna for the lower frequency (instead of a waveguide) reduces the overall size of the apparatus.

The use of an antenna therefore allows for a smaller-form apparatus when using lower RF frequencies e.g. 400-500 MHz in our case. As discussed above, the use of a lower frequency allows for a greater penetration of the RF energy into the sample being dried or cooked. The advantage of this is that larger mass samples can be processed in a homogenous manner. Accordingly, material of different sizes can be processed in a chamber of a given size.

Using an antenna for 400-500 MHz and single or multiple waveguides for 2.4-2.5 GHz thus enables us to make use of a smaller chamber when a smaller chamber is required.

Although an antenna could also be used for 2.4-2.5 GHz frequency, a waveguide is still preferable as this will give a different mode of cavity excitation compared to an antenna, which is by design a requirement in order produce a more homogenous electromagnetic environment and therefore end product.

The electromagnetic wave form propagated by a waveguide and by a “free space” antenna are different. Advantageously, this enables greater control of the microwave field strength in different regions of the chamber as compared to equipment using two waveguides. The antenna radiates omnidirectionally, whereas waveguides are directional.

The vacuum system is coupled to the chamber and operable to reduce the pressure in the chamber to less than atmospheric pressure so as to enhance the effectiveness of the drying process. The vacuum system may vary the pressure of the processing chamber of the microwave oven and depressurise the chamber pressure to less than atmospheric pressure, while the microwave oven is in operation. The vacuum system may be controlled by a controller.

Depressurisation is advantageous for both drying and cooking. By reducing the pressure inside the chamber, the boiling point of water in the food sample is reduced. Food can therefore be dried at lower temperatures when compared to an apparatus without a vacuum system. This may be advantageous for foodstuffs that require lower processing temperatures or to reduce the likelihood of overcooking. The same vacuum system that is used to depressurise the chamber can be used to extract the water vapour and steam generated during the microwave processing. By removing water in this way, drying is improved when compared to microwave ovens that operate without any water vapour extraction means. Using a vacuum chamber therefore allows for the drying/heating of products/samples in batches with the chamber at low pressure. Depressurisation also decreases convection streams, thereby reducing convection cooling. As a result, heating is accelerated.

The first microwave generator and second microwave generator may be solid state power generators. Preferably, the apparatus further comprises a safety switch configured to stop all microwave generation when the switch is open.

The apparatus may further comprise sensors configured to measure the forward power and reflected power of the first, second and/or multiple microwave power generators. The apparatus may further comprise an optical sensor, for example a spectroscopic multivariate sensor or SWIR sensor, configured to obtain spectroscopic data of a sample placed inside the processing chamber during operation for measurement and collection of data (in real time) relating to a plurality of variables and characteristics (e.g. moisture, end-point, fat content, residual moisture, protein content).

The apparatus may further comprise a controller, such as a PLC, configured to control the generation of microwave radiation from the first, second and/or multiple microwave generators. Control of the microwave generators will comprise controlling the power, phase, frequency, uniformity or other characteristic of the microwave radiation. The controller may also be configured to control the vacuum system. The controller may be configured to control the RF sources and emitters according to control parameters received from a remote-control system.

Data is thereby collected in real-time, including sample characteristics and distribution within the chamber/cavity, in addition to monitoring the power levels of the microwave generators or programming the apparatus in advance. This enables the conditions in the chamber to be varied, and to vary the conditions in different parts of the chamber independently, in order to process sample such that the sample has specific characteristics after processing is complete.

In addition to a spectroscopic or SWIR sensor (which may be configured to determine the proportion or amount of water being heated or vapourised from the foodstuff, for example), other sensors may also be provided for measuring or detecting parameters indicative of other characteristics of the foodstuff, for example vitamins, or enzymes, or chemicals formed during processing. Alternatively or additionally, signals generated by the IR sensor can be analysed (preferably by a machine learning program, as discussed in further detail below) to determine various different characteristics of the foodstuff.

The apparatus may further comprise: a plurality of waveguides disposed in or at the chamber each configured to couple the microwave radiation from the first microwave generator or a plurality of first microwave generators to the chamber; and/or one or more antenna disposed in or at the chamber, the or each antenna being configured to couple the microwave radiation from the second microwave generator, or a plurality of second microwave generators, to the chamber.

There may be varying numbers of waveguides and antennas, more waveguides than antennas, more antennas than waveguides, or the same number of each. For example, there may be provided two waveguides and one antenna, or one waveguide and two antennae, or two of each. Each antenna can be configured to transmit microwave radiation from one shared microwave generator. Alternatively, each antenna can be configured to transmit radiation from one of a plurality of microwave generators. Similarly, more than one waveguide can be configured to receive power from one microwave generator by the use of a splitter. The antenna may be used for radiating both first and second microwave frequency bands.

The apparatus may comprise a phase modifier to modify, or shift, the phase of radiation emitted by one microwave emitter (e.g., the antenna) relative to the other microwave emitter (e.g. the waveguide). Phase adjustment can be used to achieve different electromagnetic field intensities at different parts of the chamber to thereby cause different parts of the chamber to dry or cook faster or slower during the processing of a batch of material/foodstuff in the chamber.

Modifying the phase of the radiation allows for greater control of the conditions within the volume of the chamber over time. If power measurements indicate that a particular region of material/foodstuff is not drying fast enough, the microwave intensity can be increased locally, and vice-versa can be decreased locally if desired.

Different types of samples can be placed in the chamber at different regions and exposed to different conditions over the drying/cooking cycle in the chamber.

According to a second aspect of the invention, there is provided a microwave food processing apparatus comprising: a food processing chamber; a first microwave generator configured to generate microwave radiation at a first frequency between 2.4-2.5 GHz; a microwave waveguide disposed in or at the chamber configured to couple the microwave radiation from the first microwave generator to the chamber; a second microwave generator configured to generate microwave radiation at a second, lower frequency between 400-500 MHz; an antenna disposed in or at the chamber, wherein the antenna is a dual band antenna configured to be excited to generate microwave radiation at the first frequency and also configured to be excited to generate microwave radiation at the second frequency; and a diplexer configured to selectively connect the antenna to the first microwave generator or the second microwave generator.

Selectively connecting the antenna to either microwave source allows for greater control to adapt the conditions in the chamber to process particular sample in the chamber, which can be varied over time as the material/foodstuff is drying/cooking.

The apparatus may have a controller configured to control the first, second and/or multiple microwave generators so as to vary RF generation or terminate RF generation from the first generator when the second generator is generating RF radiation at the second frequency. Alternatively or additionally, the controller may be configured to control the second microwave generator so as to vary RF generation or terminate RF generation when the first microwave generator is generating RF radiation.

Control of RF radiation generation in this way ensures that the antenna is only emitting at one frequency (dependent upon which microwave generator is turned on) and enables processing cycles that use both the higher and lower frequency sequentially. For example, the controller may operate the second microwave generator at 400-500 MHz for a period of time to cook/dry the interior of the material/foodstuff, then operate the first microwave generator at 2.4-2.5 GHz for a period of time to make the surface of the material/foodstuff crispy.

The first and/or second microwave generator may comprise a solid-state microwave power generator. The power and phase of microwave emissions from the solid-state power generators (SSPGs) can be easily controlled.

The antenna may also be capable of being excited at 2.4-2.5 GHz by the second generator. Use of a dual band monopole antenna allows the antenna to efficiently emit both 400-500 MHz and 2.4-2.5 GHz radiation. As discussed above, it is desirable to have an antenna capable of emitting 400-500 MHz radiation as waveguides are too large. The ability of the antenna to also emit 2.4-2.5 GHz radiation is advantageous as the antenna may be operated simultaneously with the waveguides for greater control of the 2.4-2.5 GHz microwave field.

A diplexer may be provided between the first and second microwave generator and the antenna to allow for selective control of the microwave bands produced by the first and second microwave generators.

There may be more than one antenna in the chamber. This increases the control of microwave drying/cooking power at any point in time over different spatial regions of the chamber.

The apparatus also comprises sensors for detecting/monitoring the forward power and reflected power, and the controller may be configured to use the monitored signals to control one or more of the pulse width modulation (PWM), power, frequency, amplitude, and phase parameters of either the first, second, and/or multiple microwave radiation generators.

According to a third aspect of the invention there is provided a microwave food processing apparatus comprising: a food processing chamber; a microwave generator system configured to generate and communicate microwave radiation to the chamber; one or more sensors configured to measure the forward and reflected power of the microwave radiation generated by the microwave generator system; and a controller configured to control the microwave radiation generated by the microwave generator system, wherein the controller is in communication with the one or more sensors and is further configured to: receive the forward and reflected power measurements from the one or more sensors; determine a value of an attribute of the foodstuff using the forward and reflected power measurements, compare the value to a desired value of the attribute and control the microwave radiation generated according to the comparison.

Sensing the conditions in real time in the chamber and the characteristics of the sample allows for greater control of processing compared to equipment which relies solely on power measurements at the generators or pre-programmed processing parameters.

The microwave generator system may comprise: a first and/or multiple microwave generators configured to generate microwave radiation at a first frequency, for example 2.4-2.5 GHz; and a waveguide disposed in or at the chamber configured to communicate the microwave radiation from the first microwave generator to the chamber.

The microwave generator system may also comprise: a second and/or multiple microwave generators configured to generate microwave radiation at a second, lower frequency, for example 400-500 MHz; and an antenna disposed in or at the chamber configured to communicate the microwave radiation from the second microwave generator to the chamber.

Phase shifting between the radiation emitters (e.g., between two waveguides, a waveguide and antenna, etc.) facilitates greater control of radiation intensity within the chamber. Such control facilitates homogeneous radiation, or at least improved homogeneity in the radiation, across the chamber, or at least across a selected part of the chamber. This can be used to deliberately achieve different conditions in different parts of the chamber, and therefore heating/drying at different intensities and in different parts of the chamber, so that different products can be simultaneously dried or cooked at different parts of the chamber. ‘Simultaneously’ means at the same time, or at different times but without having to open the chamber and remove one of the samples/foodstuffs before processing the other. For example, two (or more) samples/foodstuffs may be loaded into the chamber and the chamber closed. The samples/foodstuffs may then be processed differently in a single operation without having to remove some of the samples/foodstuffs between applying power to different areas of the chamber differently. This simplifies the requirements for the user—they simply have to load samples/foodstuffs once at the beginning of the operation, rather than add and remove samples/foodstuffs at multiple different times.

According to a fourth aspect of the invention, there is provided a system for controlling operation of a microwave sample processing apparatus, the system comprising;
one or more processors for processing data; storage for storing a plurality of processing profiles, wherein each processing profile comprises data which defines one or more characteristics of a processed sample, and for storing one or more recipes, wherein each
recipe comprises data defining one or more characteristics of a processing cycle; a machine learning module configured to:
receive first sensor data from one or more sensors in the microwave sample processing apparatus, wherein the sensor data comprises data relating to characteristics of the sample
receive second sensor data relating to conditions within the apparatus,
process the first and second sensor data according to one or more machine learning
algorithms, and output quantitative values of characteristics of the sample; wherein the one or more processors is configured to
compare the quantitative values to a preselected profile, and
generate control information, wherein the control information is configured to modify operational parameters specified by a preselected recipe so as to converge the signals from the sensors towards the preselected profile, and
send control information to the microwave processing apparatus.

The machine learning module may be at least partially run on a remote cloud computing platform, which can provide the computational power required.

According to a fifth aspect of the invention, there is provided a method of processing matter in a dual-frequency microwave processing apparatus, comprising: placing the sample inside of the microwave processing apparatus; optionally operating a vacuum system to reduce the pressure inside the microwave processing apparatus to less than atmospheric pressure; operating a microwave generation system to selectively apply microwave radiation to the food sample in order to heat the food sample, thereby removing water contained in the food sample; measuring characteristics of the applied microwave radiation and of the sample under processing and controlling the vacuum system and/or microwave generation system in response to the measured characteristics.

The use of vacuum and microwave radiation may also have the benefit of reducing convective heating to achieve faster heating and more desirable properties of the food sample (for example taste or texture).

The method may involve using microwave radiation of two frequencies, for example 2.4-2.5 GHz and 400-500 MHz, and selectively applying them to the sample under processing, sequentially.

The method may involve pausing the operation of the vacuum system and microwave generation, thereby allowing a user to access the interior of the microwave processing chamber to, for example, add, remove or move around samples.

The method may involve using an artificial intelligence module to process sensor data and determine characteristics of the sample, and then generate control information to control the vacuum system and/or microwave generation system in response to the measured characteristics of the applied microwave radiation and/or the sample so as to process the sample according to set parameters within the operating chamber (a ‘recipe’) to achieve defined characteristics of the organic sample (a ‘profile’).

According to a further aspect of the invention, there is provided a method of irradiating materials at a frequency selected from 400-500 MHz or 2.4-2.5 GHz band, under vacuum conditions. Preferably, the method exclusively utilises solid-state power generators (SSPGs). Both antennae and waveguide-type power couplers are preferably used independently of one another or in combination with one another.

The method may further include variating the EM field within a process chamber by manipulation of wave interference patterns such that distinct bodies contained within the process chamber can be heated at different rates. Furthermore, the method may further comprise discovering the most effective method for achieving a product's Quality Target Product Profile using an atmosphere control means, a power generating means, a control means, and a machine learning engine. Optionally, at least one indium gallium arsenide (InGaAs) photodiode sensor array (spectroscope) converts spectroscopic data into chemical and physical properties on the basis of previously developed machine learning predictive models.

### BRIEF DESCRIPTION OF THE DRAWINGS

Embodiments of the invention will be described by way of example with reference to the accompanying drawings, in which:

FIG. 1x is a schematic of a microwave heating apparatus according to an embodiment of the invention;

FIG. 2x as a schematic of a microwave heating apparatus according to an embodiment of the invention;

FIG. 3^{x} is a schematic of a control system for a microwave heating apparatus, in accordance with an embodiment of the invention;

FIG. 4^{x} is a schematic of a microwave power generation system according to an embodiment;

FIG. 5x shows representations of a simulation of the electromagnetic field produced and S-response of a heating cavity;

FIG. 6^{x} shows a representation of a simulation of a electromagnetic field generated by lower frequency radiation compared to the simulation of FIG. 5;

FIG. 7^{x} is a microwave processing apparatus according to an embodiment of the invention;

FIG. 8^{x} is a flow chart illustrating an example method for processing foodstuffs according to an embodiment of the invention.

### DETAILED DESCRIPTION

Referring to FIG. 1^{x}, an example apparatus 100 is shown for the microwave processing of materials. The apparatus 100 comprises a food processing chamber 101. The chamber 101 may have a door, hatch or other sealable opening to allow for food or other materials to be placed in the chamber 101 for processing. In some embodiments, the interface between the door or hatch and the food processing chamber 101 may be sealed by means of a gasket constructed from an electrically conductive material such as nickel-graphite silicon. The chamber 101 may comprise a parallelepiped or cylindrical structure constructed from, for example, stainless steel.

The apparatus 100 further comprises a first microwave generator 110 configured to generate microwave radiation at a first frequency. The first frequency may be 2.4-2.5 GHz. A waveguide 111 is provided for communicating the microwave radiation of the first frequency to the chamber 101. The waveguide 111 may comprise angled or otherwise additional components 112 to allow for practical positioning and coupling of the first microwave generator 110. The waveguide 111 may be a commercially available waveguide, such as a WR340 or WR430 waveguide.

The apparatus 100 further comprises a second microwave generator 120 configured to generate microwave radiation at a second, lower frequency. The second frequency may be 400-500 MHz. An antenna 121 is provided for communicating the microwave radiation of the second frequency to the chamber 101. The antenna 121 may be coupled to the second microwave generator by a coaxial cable 122. The antenna 121 may be a monopole antenna.

By using a first frequency such as 2.4-2.5 GHz and a second, lower frequency such as 400-500 MHz, food samples may be heated both at the surface and internally. 2.4-2.5 GHz is suitable for heating/drying of foods to depths of approximately 25 mm, while 400-500 MHz is suitable for heating/drying foods to depths of approximately 300 mm. The two frequencies may be applied sequentially depending on the processing requirements of the food sample.

The use of an antenna 121 for transmitting the microwave radiation of the second frequency to the chamber 101 may be more practical and convenient that other techniques. Compared to the waveguides designed for lower frequency microwaves (such as the WR2300 waveguide), the antenna may have a smaller spatial footprint. This may allow the apparatus 100 of FIG. 1x to be used in smaller commercial settings.

The use of two frequencies in apparatus 100 may also allow for improved control of the electromagnetic field inside of the chamber 101. As will be discussed in more detail later, the two frequencies may be controlled individually and sequentially to create a desirable heating pattern in the chamber 101.

This may be further enhanced by the use of both a waveguide 111 and antenna 121 for coupling of the microwave radiation to the chamber 101. The waveguide 111 and antenna 121 have substantially different propagation patterns, the waveguide 111 being an ideally one-dimensional propagation, and the antenna being an ideally free-space emitter. Experimentation has shown that the combination of a waveguide and an antenna provides for sufficient control of the electromagnetic field to create a uniform heating pattern. The use of a waveguide for the 2.4-2.5 MHz microwave radiation eliminates the need for custom design compared to an antenna, and as discussed earlier does not have the spatial footprint drawbacks of the second, lower frequency.

Referring to FIG. 2^{x}, another example apparatus 200 is shown that allows for the microwave processing of materials to be controlled. Similar to the apparatus of FIG. 1, the apparatus 200 comprises a food processing chamber 101, a first microwave generator 110 coupled to a waveguide 111, and a second microwave generator 120 coupled to an antenna 121.

The apparatus 200 further comprises a vacuum system 130 that is fluidly coupled to the chamber 101. The vacuum system 130 is configured to reduce the pressure inside the chamber 101 to less than atmospheric pressure. Reducing the pressure inside the chamber 101 may aid in the drying of foods processed in the chamber by reducing the boiling point of water within the food sample. This may be beneficial for processing of foods that necessarily require lower processing temperatures (for example delicate foods that burn at non-depressurised processing temperatures). The vacuum system 130 may also be configured to extract water vapour from the chamber 101 during operation.

The microwave generators 110 and 120 are preferably solid-state power generators (SSPGs). SSPGs can be configured to generate microwave radiation of varying amplitude, frequency and phase. As is typical of SSPGs, the power generators may comprise sensors 113 and 123 configured to measure the power generated by the SSPG and the power received by the SSPG from the surrounding environment, known as the forward and reflected power, respectively. These power measurements are communicated to controller 150, which may use the forward and reflected powers to control the microwave generators 110 and 120.

The apparatus 200 further comprises one or more spectroscopic analysers 140, spectroscopic 1 sensor 140 is configured to sense wavelengths in the near infrared (NIR) range from 0.8 to 1.0 μm or shortwave infrared (SWIR) range from 0.9 to 1.7 μm. The spectroscopic sensor is provided with an ad hoc sensing probe specially designed for operating under radiofrequency radiation and vacuum conditions. The sensor 140 may be configured to capture spectroscopic data of a food sample while the sample is being microwave processed. The spectroscopic data may contain multivariate information about the chemical composition of the sample. By measuring the spectroscopic signature of the sample, the sample's fat, water, micronutrient, mineral or vitamin content or Maillard reaction end-point, for example, can be inferred by using the appropriate machine learning model. The data provided by the sensor may be used by the controller 150 to set the adequate operation conditions as well as to provide nutritional and organoleptic information to characterize the quality of the finished product.

The apparatus 200 may further comprise a controller 150 configured to control the microwave generators 110 and 120. The controller is in electronic communication with all or some of the SSPG sensors and the RF power sensors and multivariate sensor 140. In one example, the controller 150 monitors the reflected power measurements of the two microwave generators 110 and 120, and automatically adjusts the forward power of the SSPGs (or other aspects of the microwave generators, such as phase) to reduce the reflected power according to generated control instructions, which may be received from a remote location. In another example, the controller receives spectroscopic data from the multivariate sensors to ascertain properties of the sample being processed and uses that information to generate control instructions to control the microwave power generators. For example, the controller 150 may be configured so that when the spectroscopic data indicates a certain infrared signature associated with a particular water content, the controller 150 automatically turns off the microwave generators to terminate the processing cycle. In a further embodiment, the multivariate sensor, combined with processing capability of the controller (as discussed further below) is configured to measure a plurality of different parameters, characteristics and/or attributes of the product being processed. The collection of different parameters can be considered a specific ‘spectral picture’ of the product. The controller may be configured to determine when a final target ‘spectral picture’ (i.e., end-point) has been achieved, which can indicate that processing of the organic sample/product should end.

Using the information provided by additional sensors such as the multivariate sensor(s) may allow for the generation of more effective control instructions compared to apparatuses that only have sensors to monitor forward and reflected power.

The controller 150 comprises manual user input means 151. In some embodiments the controller 150 may allow the user to manually enter processing parameters via the input means 151, such as microwave power level, processing time, or desired material properties (such as a desired water content). The controller may use these manual parameters in combination with the sensor information above to control the microwave generators. The controller 150 may also comprise a visual display to indicate parameters or the progress of processing to the user via the input means 151.

The apparatus herein described can be programmed to dry, cure, cook, heat, pre-heat, or defrost physical materials. The system controller 150 may be configured to automatically control the following process parameters:
the power generated by each SSPG from Pmin to Pmax;
the phase of the EM FIELD generated by each SSPG;
the frequency of the EM FIELD generated by each SSPG
the energy Q transferred to a sample of physical material contained within the process chamber;
the minimum and maximum temperature of a sample of physical material contained within the process chamber;
the vacuum pressure within the process chamber;
the maximum water content of a sample of physical material contained within the process chamber;
the process time interval.

The following process parameters can be manually controlled by a user independently of one another:
the power generated by each SSPG from Pmin to Pmax;
the energy Q transferred to a sample of physical material contained within the process chamber;
the minimum and maximum temperature of a sample of physical material contained within the process chamber;
the vacuum pressure within the process chamber;
the maximum water content of a sample of physical material contained within the process chamber;
the process time interval.

Examples of manually configured programs (i.e., ‘recipes’):

### Example:

Transfer energy to a sample at a rate of 500 W at a frequency of f1 for a period t=0→720 (s).

### Example:

Transfer energy to a sample at a rate of 1000 W at a frequency of f2 for a period t=0→180 (s);
Transfer energy to a sample at a rate of 1000 W at a frequency of f1 for a period t=180-720 (s)

### Example:

Transfer energy to a sample at a rate of 500 W at a frequency of f2 for a period of t=0→60 (s);
Transfer energy to a sample at a rate of 1000 W at a frequency of f2 for a period of t=60→180 (s);
Transfer energy to a sample at a rate of 500 W at a frequency of f1 for a period of t=180→300 (s);
Transfer energy to a sample at a rate of 1000 W at a frequency of f1 for a period of t=300→480 (s).

### Example:

Set vacuum pressure at 70 kPa for a period of t=0→480 (s);
Transfer energy to a sample at a rate of 500 W at a frequency of f2 for a period of t=0→60 (s);
Transfer energy to a sample at a rate of 1000 W at a frequency of f2 for a period of t=60→180 (s);
Transfer energy to a sample at a rate of 500 W at a frequency of f1 for a period of t=180→300 (s);
Transfer energy to a sample at a rate of 1000 W at a frequency of f1 for a period of t=300→480 (s).

### Example:

Set vacuum pressure at 70 kPa for a period of t=0→240 (s);
Set vacuum pressure at 70 kPa for a period of t=240→480 (s);
Transfer energy to a sample at a rate of 500 W at a frequency of f2 for a period of t=0→60 (s);
Transfer energy to a sample at a rate of 1000 W at a frequency of f2 for a period of t=60→180 (s);
Transfer energy to a sample at a rate of 500 W at a frequency of f1 for a period of t=180→300 (s);
Transfer energy to a sample at a rate of 1000 W at a frequency of f1 for a period of t=300→480 (s).

### Example:

Set vacuum pressure at 70 kPa for a period of t=0→240 (s);
Set vacuum pressure at 70 kPa for a period of t=240→480 (s);
Transfer energy to a sample at a rate of 500 W at a frequency of f2 for a period of t=0→60 (s);
Transfer energy to a sample at a rate of 1000 W at a frequency of f2 for a period of t=60→180 (s);
Transfer energy to a sample at a rate of 500 W at a frequency of f1 for a period of t=180→300 (s);
Transfer energy to a sample at a rate of 1000 W at a frequency of f1 for a period of t=300→480 (s).

### Example:

Reduce water content to 80%.
Limit product temperature to 49° C.

### Example:

Raise product temperature to 70° C.
Maintain product temperature @70° C. for a period of t=0→60 (m).

### Example:

Raise product temperature to 70° C.
Maintain product temperature @70° C. for a period of t=∞ (m).

### Example:

Raise product temperature to 70° C.
Maintain product temperature @70° C. for a period of t=0→10 (m).
Reduce product temperature to 5° C.

In these examples, recipes are based on control blocks. The control blocks may be configured independently of one another and may run in series or in parallel to one another. The system controller 150 may be configured to alert the user if specific blocks/commands conflict with one another.

Referring to FIG. 3^{x}, another example apparatus 300 is shown that allows for the microwave processing of materials to be controlled. Similarly, to the apparatus of FIG. 1^{x}, the apparatus 300 comprises a food processing chamber 101 and a second microwave generator 120 coupled to an antenna 121.

Apparatus 300 comprises two first microwave generators 110a and 110b, coupled individually to waveguides 111a and 111b respectively. Both microwave generators 110a and 110b are configured to generate a first microwave frequency of 2.4-2.5 GHz. In other example embodiments, more microwave generators may be provided to generate a first microwave frequency, each coupled to a waveguide. Alternatively or additionally, a plurality of second microwave generators may be provided, each coupled individually to an antenna. The additional waveguides and/or antennas may be positioned in the chamber 101 so as to create a more uniform electromagnetic field or otherwise allow easier control of the field.

As before, sensors that measure the forward and reflected power, are provided in order to measure parameters of the sample and conditions in the chamber 101.

Chamber 101 comprises a load system 102 upon which at least one removeable receptacle can be placed. The load system may comprise multiple shelves or guide slots wherein racks, grids, and a variety of gastronome-type containers may be secured.

Apparatus 300 includes a multivariate optical sensor 140, which may be a self-contained infrared spectrometer. A visible light source may also be provided in some embodiments.

An example of the vacuum system 130 is shown in FIG. 3^{x} in greater detail. The example vacuum system 130 comprises a pump 131 that is fluidly coupled to the chamber 101 via pipes or tubes. In this example the vacuum pump 131 is also electrically connected to the controller 150. The controller 150 is configured to operate the pump 131 so that the chamber 101 is kept at a desired pressure. The example vacuum system 130 further comprises a condenser, which is configured to extract volatised water molecules from the chamber 101 alongside extracted air, which enables more efficient drying of foods. The vacuum system 130 also has a relief valve 133 that is also controllable by the controller 150 to allow air back into the chamber 101 as desired, and an exhaust 134 for exhausting air and/or water vapour extracted from the chamber 101.

Apparatus 300 preferably further comprises a pressure sensor 103 (for example a pressure transducer) to directly measure pressure inside the chamber 101. The apparatus 300 may also comprise other additional sensors 104. These sensors may be digital or analogue sensors configured to measure additional environmental parameters of the chamber 101, for example temperature. The additional sensors 103 and 104 may be electronically connected to the controller 150 so that the controller 150 can use measurements of environmental parameters when controlling the microwave power generators 110a, 110b and 120 and the vacuum system 130.

In preferred embodiments, system 157 is used in conjunction with local controller 150, to control apparatus 300. System 157 comprises machine learning engine 152.

System 157 further comprises a collection of recipes and power operating profiles in storage 156 in on a cloud computing platform 155. Apparatus 300 may comprise an internet adapter 153 (such as a WiFi adapter or LAN port) so that the controller 150 may connect to the cloud platform 155 via an internet connection 154. Apparatus 300 further comprises a human-machine interface (HMI) 151 that allows for input commands to be entered manually to the controller by the user or for displaying information to the user.

The controller 150 is connected to the microwave power generators 110a, 110b and 120 and any power sensors associated with these, the vacuum system 130, the infrared sensor 140 and any additional sensors 103, 104 of the apparatus 300. The controller 150 collects all of the feedback and measurement data from these various sources to ascertain the status of the environment inside the chamber 101. Machine learning engine 152 receives and processes this information to determine value of specific properties, parameters or characteristics of the organic sample. Profiles in storage 156 each describe expected measurements (conditions in the chamber 101) that result in a desired food product. Based on a comparison of the recipe 156 and the feedback measurements, control routines of the machine learning engine 152 can then provide feedback to the controller 150 regarding what control steps need to be taken to keep the conditions in accordance with parameters specified by the selected recipe. Controller 150 may then provide a control signal to any of the microwave power generators 110a, 110b, 120 or the vacuum system 130 to meet the desired environmental conditions according to recipe 156.

A recipes 156 can be selected manually before the processing cycle begins by the user via the HMI 151, effectively instructing the apparatus 300 to follow a desired processing profile. The machine learning engine 152 may also be trained to optimise existing recipes based on user generated supervision data (i.e. indications from a user that the organic sample has been successfully processed).

The controller 150 may be configured to acquire data in real-time and any data acquired may be interpreted by the controller 150 as:
i) an instruction sent by a system control algorithm stored in local memory or cloud memory;
ii) an instruction sent by an operator via the HMI or by a connected device;
iii) an expression of the amplitude, phase, or frequency of any electromagnetic waves communicated to the process chamber;
iv) an expression of the operating temperature of a SSPG;
v) an expression of the amplitude of any electromagnetic waves reflected by the process chamber and/or the contents of the process chamber.
vi) an expression of the pressure of the atmosphere contained within the process chamber.
vii) expressions of the properties of any physical material contained within the chamber, including, for example, a sample's temperature profile and/or chemical composition.

The controller 150 may interpret data as expressions of the initial conditions of any physical material contained within the process chamber 101. Such data may include both manually input and automatically derived values. Such data may be related to, for example: the definition of the physical material; the initial weight of the physical material; the type and material of the receptacle the physical material is positioned on or within; the number of units of physical material contained within the process chamber 101; and the local coordinates of each unit.

The controller 150 may be configured to acquire data related to the pressure within the process chamber 101 by means of the pressure transducer 103. The controller 150 may be configured to decrease the vacuum pressure within the process chamber 101 by closing the proportional relief valve 133 and increasing the vacuum pump 131 speed, and to increase the vacuum pressure by opening the proportional relief valve 133 and decreasing the vacuum pump 131 speed.

The controller 150 may interpret data related to the power received by an antenna 6 as an expression of the power reflected by the structure of the process chamber 10 and its contents. If the non-load characteristics of the process chamber 10 are known, forward and reflected power measurements can be used to determine the power absorbed by any physical material contained within it, where the absorbed power is given as Pabs=Pfwd−Pref1. If the absorbed power and the process duration are known, the total energy converted into heat Q can be determined by Q=∫_(t_1)\hat{ }(t_2) [symbol] P_abs dt. The effects of heat on a particular environment can be determined by experimentation and a statistical/data-driven model can be constructed from the acquired data. Such a statistical model can form the basis of a control algorithm that is designed to minimise any divergence between the data obtained during further iterations and the data contained within the prototypical or ideal statistical model. An AI tool operating on the cloud platform may construct statistical models related to the physical condition of any physical material contained within the process chamber 100 in real-time. The accuracy of such models is a function of the quantity and quality of data that can be acquired by the system controller 100.

For example, the system controller may be configured to command a SSPGf1 to transfer energy to a sample at a rate of P1 at a frequency of f1 for a period of t, where:
P1=the amount of energy transferred or converted by SSPGf1 per unit time;
f1=the frequency of the waveforms generated by SSPGf1
t=the time period

In an example embodiment, P1 can be varied between 0 and the maximum power that can be generated by SSPGf1; and f1 can be varied between 2.4-2.5 GHz. The system controller may be configured to command a SSPGf2 to transfer energy to a sample at a rate of P2 at a frequency of f2 for a period of t,
P2=the amount of energy transferred or converted by SSPGf2 per unit time;
f2=the frequency of the waveforms generated by SSPGf2 and
t=the time period”

In an example embodiment, P2 can be varied between 0 and the maximum power that can be generated by SSPGf2 or combinations thereof; f2 can be varied between 400-500 MHz.

FIG. 4ₓ shows a further embodiment of a microwave food processing apparatus. Apparatus 400 comprises a chamber 101. Similarly to the embodiment shown in FIG. 3^{x}, the apparatus 400 comprises two first microwave generators 110a and 110b, coupled individually to waveguides 111a and 111b respectively. The chamber 101 and electronics of the apparatus 400 may be suitably earthed via an earthing terminal 105.

Apparatus 400 further comprises a further first microwave generator 110c and a second microwave generator 120. The plurality of first microwave generators 110a-110c produce microwaves with a first frequency such as 2.4-2.5 GHz, and the second microwave generator 120 produces microwaves with a second, lower frequency such as 400-500 MHz. First microwave generator 110c and second microwave generator 120 are both connected to an antenna 121 that is configured to be efficiently excited at both the high and low frequencies of 2.4-2.5 GHz and 400-500 MHz MHz. The two microwave frequencies are provided to the antenna 121 via a diplexer 124. The diplexer 124 has sufficient isolation (<−20 dB) so that the antenna can radiate at both the high and low frequency depending on which power generator 110c and 120 is active.

Apparatus 400 also comprises controller 150 in communication with the microwave generators. The microwave generators are preferably SSPGs and sensors to measure the forward and reflected powers of each power generator may be provided. As discussed above, the controller 150 may use this information to control the power generators to, for example, improve the uniformity of the field produced, improve the efficiency of power delivery, or meet a desired environmental parameter in the chamber 101.

FIGS. 5A^{x} and 5B^{x} show simulations of the expected electromagnetic response for an embodiment of the microwave processing apparatus similar to that shown in FIG. 4x The apparatus comprises two waveguides that deliver microwave radiation of 2.4-2.5 GHz to the chamber, and a dual-frequency antenna that may deliver 400-500 MHz or 2.4-2.5 GHz microwave radiation to the chamber. The simulation was conducted using 2.45 GHz radiation in this instance.

In the simulation, the antenna is positioned so that all three of the power couplers (antenna and waveguides) were resonating within the 2.4-2.5 GHz band. The electromagnetic field generated by the power couplers is multi-modal, but as shown in FIG. 5A^{x}, is substantially uniform across the cavity. Similarly, the waveguides were positioned to maximise the efficiency of microwave communication to the chamber and to avoid interference between the two waveguides. FIG. 5B^{x} shows the S-parameter response of the 3 power couplers. The graph shows that all of the power couplers have S-parameters of less than −10 dB across the 2.4-2.5 GHz range, corresponding to greater than 90% efficiency of microwave power transferred to the chamber.

The separation between the two waveguides is set to an odd multiple of half wavelengths of the 2.45 GHz microwave radiation. In FIGS. 5Aₓ and 5B^{x} the waveguides are positioned with a separation of 9λ/2. The broadband nature of the resonating structure is preserved for different odd multiples, meaning that the antenna and waveguide approach of the present invention may be scaled to different sized chambers. This may mean that the approach may be scaled to smaller commercial apparatuses or large industrial apparatuses.

By ensuring that the power couplers generate a uniform field, homogenous heating of food samples may be enabled. A uniform field may mean that food can be processed without the need for mechanical movement of the foodstuff within the chamber as the entire food sample processes at the same rate. This eliminates the need for additional mechanical components, reducing cost and maintenance requirements.

In alternative embodiments, the power couplers may be positioned so that the electromagnetic field is deliberately non-uniform, creating areas with different field densities. Alternatively, this may be achieved by varying parameters of the power couplers, for example controlling the power or phase each of the waveguides and antenna so that a non-uniform field is achieved.

The non-uniform field may be advantageous for the processing for multiple food samples simultaneously. For example, the microwave processing apparatus may be configured so that an area near the top of the chamber has a high field density, while an area near the bottom of the chamber has a lower field density. A food sample that requires high temperature processing could be placed at the top of the chamber, and a different food sample that requires low temperature processing could be placed at the bottom of the chamber, allowing for both samples to be processed as desired at the same time.

The controller may be configured to adjust the phase or power of the microwave generators in order to help produce a desired electromagnetic field. Controller 150 may command the microwave generators to be in phase or out of phase with one another. By controlling the interference effects between different power couplers, advantageous field intensities may be produced in different regions of the chamber.

The controller may be configured to command one or more SSPGf1 to generate an EM field, F1, and one or more SSPGf1 to generate an EM field, F2, where F1 and F2 are in phase. Where F1 and F2 interfere with one another, the amplitude of the resultant EM field will be the sum of the amplitudes of F1 and F2.

The system controller may be configured to command one or more SSPGf1 to generate an EM field, F, and one or more SSPGf1 to generate an EM field, G, where G is a phase-shifted version of F and the phase shift between F and G is given by φ(t)=ϕG(t)−ϕF(t). Where F and G interfere with one another, the amplitude of the resultant EM field is given as a function of φ(t).

The system controller may be configured to excite a specific power coupler or combination of power couplers at different phases. This has a number of advantages: Localised interference phenomena can be generated within the process chamber by means of constructive and/or destructive interference, such that field intensity can be varied throughout the chamber. This enables the heating of some samples more than others depending on their respective positions within the process chamber. It follows that different samples of physical material with distinct physical properties and characteristics can also be processed simultaneously if they are placed at specified positions within the process chamber.

Controller 150 may be configured to instruct the operator to insert operator specified samples of physical material at specific positions within the process chamber at specific times, and, similarly, to remove user specified samples of physical material from specific positions within the process chamber at specific times, based on its own statistical models of the samples. Consider that the user wishes to process three samples of physical material of varying physical composition, sample A, sample B, and sample C, wherein the user identifies sample A, sample B, and sample C and, further, specifies that the samples belong to a set {Ticket 1} that should be completed at the same time: The control means may then instruct the user to insert sample A to grid position 1 at t1, to add sample B to grid position 5 at t2, and to add sample C to grid position 9 at t3, so that the processing of each sample terminates at the same time. Alternatively, the user may instruct the control means to process each sample as soon as possible, whereby the control means may instruct the user remove sample A at t5, to remove sample B at t6, and to remove sample C at t7.

Process efficiency can be defined as (eff)=(Pfwd−Pref1)/Pfwd. Ideal performance infers that maximum efficiency is maintained throughout a process. If a physical material is transformed, its dielectric properties change, and these changes will ultimately affect process efficiency. The most effective method is therefore one in which EM FIELD characteristics can be adjusted in real-time so that maximum efficiency is maintained throughout. That is to say, the most effective method is one which selects the optimal power, frequency, and phase parameters for each stage of the process such that Pref1 is minimised during every interval. The system controller 150 may be configured to periodically monitor and control Pref1 such that Pref1 is minimised to the furthest extent possible. However, the system controller 100 may sacrifice efficiency when processing different samples of physical material so that such samples can be processed simultaneously. For example, if the processing of sample A is to terminate simultaneously with the processing of sample B, and sample A and sample B are statistically distinct from one another, the system controller 150 may employ interference techniques to ensure termination is simultaneous: Such processes will be less efficient than those for which the system controller 150 is configured to maximise efficiency by means of minimising Pref1.

In addition to configuring the separation of the power couples (such as the separation between waveguides) and the parameters of the microwave generators (such as power and phase), the dimensions of the chamber itself are also configured to produce a desirable electromagnetic field. By adjusting the dimensions of the chamber, the antenna and waveguide can be efficiently coupled to the chamber, creating a resonant response. This may allow for more efficient communication of microwave power to the foodstuff in the chamber, or better control of uniform or non-uniform fields. In the simulations of FIGS. 5A and 5B, a chamber was used with a width of approximately 60 cm, depth of approximately 65 cm and height of approximately 50 cm. Chambers with other dimension may be used with other arrangements for antenna and waveguides to produce the desired resonant response.

Referring to FIG. 6^{x}, the dual-frequency antenna is also optimised for operation in the 420-450 MHz frequency range. The simulation shows that when the antenna is operated with 433.05 MHz microwave radiation under TE101 mode (the dominant mode of the cavity, referring to a Transverse Electric mode where the 1, 0 and 1 refer to the number of half wavelength variations in the x, y, and z directions respectively), the result is an electromagnetic field with a well-defined single resonant mode. This means that there are no hot spots within the chamber, which may allow for more uniform heating of food samples with this second lower frequency also. As discussed previously, both the 2.4-2.5 GHz and 433.05-434.79 MHz may be used in the processing due to their differing penetration properties. By optimising the apparatus for use with both frequency ranges, more efficient dual-frequency processing may be achieved.

Referring to FIG. 7^{x}, the microwave processing apparatus 500 is similar to that described previously in FIG. 4. The apparatus 500 comprises a processing chamber 101, two waveguides 111a, 111b and an antenna 121. As will be described, a specific location and arrangement of the waveguides 111a, 111b and the antenna 121 have been discovered to be advantageous. FIG. 7^{x} is to scale and the positioning of the components can be determined from it.

The waveguides 111a, 111b and the antenna 121 are separated by odd multiples of half wavelengths of 2.45 GHz microwaves. The wavelength of 2.45 GHz microwave radiation is 12.24 cm. Using separations of odd multiples of half wavelength ensures that the interference between the electromagnetic waves radiating from the waveguides 111a, 111b and antenna 121 is null such that it does not make the overall structure a reflector and the broadband nature of the resonating structure is preserved.

In this example, the separation AB of the centres of the two waveguides 111a, 111b is nine half wavelengths; the separation AC of the centre of the antenna 121 and centre of the first waveguide 111a is three half wavelengths; and the separation BC of the centre of the antenna 121 and the second waveguide 111b is seven half wavelengths. This is based on a wavelength of 2.45 GHz microwave radiation (12.24 cm).

These separations were tested and found to be optimal for the chamber 101, shown in the example, with a width of approximately 60 cm, depth of approximately 65 cm and height of approximately 50 cm. Testing has shown that the broadband resonant behaviour and electromagnetic field uniformity is preserved when the separations are altered to different old multiples of half wavelength. As such the separations may be increased (to say 11, 13, 15, etc half wavelengths) without affecting the resonant properties of the cavity, thereby allowing apparatus 500 to be scaled to larger units which may be suitable for industrial uses.

The chamber 101 is designed and scaled so that it acts as a well-defined single mode cavity in the 433-434 MHz band and a multimode cavity in the 2.4-2.5 GHz band, thus allowing both frequencies to be used efficiently in the same apparatus. As discussed previously, use of both frequencies may be beneficial in the processing of foods as both the surface and interior of the food can be heated.

The use of antenna 121 in a microwave processing apparatus may be beneficial as the antenna 121 is substantially smaller than typical waveguides for 400-500 MHz microwaves. For example, the WR2300 waveguide has a spatial footprint of 266.7×533.4 mm. This width of more than 50 cm is a significant portion of the chamber 101 shown in FIG. 7^{x}. Hence, the use of such a waveguide for the 400-500 MHz radiation in this apparatus would not be practical as it would severely limit the positioning of the 2.4-2.5 GHz waveguides, and would not be possible on chambers that are smaller than this example. The antenna 121 is thus more practical than a waveguide solution and may be used on smaller, commercial apparatuses.

Referring to FIG. 8, there is provided an example of a method 1000 for processing organic matter in a microwave processing apparatus. The microwave processing apparatus may be similar to that of any embodiment described previously.

Firstly, at step 1001, the food sample is loaded into the chamber of the apparatus. Samples may be held on trays, containers or other receptacles when placed in the chamber. The food may be deliberately placed in a certain area of the chamber depending on the electromagnetic field to be applied. The controller or a HMI may be configured to instruct the user of where in the chamber food samples should be placed for the most effective or desired processing.

At step 1002, the vacuum system is operated to reduce the pressure in the chamber below atmospheric pressure. The desired pressure may be input manually by the user or may be pre-programmed as part of a desired process recipe. In some examples, the vacuum system may not be used if vacuum/drying is not required, for example if the food stuff simply requires thawing.

At step 1003, the microwave generation system is operated in order to apply microwave radiation to the food sample. As above, the microwave radiation to be applied may be input manually by the user or may be pre-programmed as part of a desired process recipe. Two microwave frequencies may be applied, such as 2.4-2.5 GHz and 400-500 MHz. The two frequencies may be applied sequentially. The frequency, power, phase or other properties of the microwave generation system may be set to establish a desired electromagnetic field in the chamber.

Sensor data may then be used to further control the apparatus when in operation 1004. This may include measurements of the forward and reflected power from the microwave generators, spectroscopic data extrapolated to determine properties of the food sample (for example water content, fat content), chamber pressure data or data from other sensors of the apparatus. The optical data may be interpreted as a spectrogram, wherein the intensity of radiation emitted by the foodstuff is measured across a range of frequencies. The vacuum system and/or the microwave generators may then be controlled in response to measurements of characteristics of the sample. For example, the microwave frequency may be changed from the first frequency to the second frequency after a certain amount of time, or the power of the microwave generators may be reduced when water content of the sample is reduced to below a desired threshold.

As discussed in previous embodiments, this measurement and control technique may be performed by an artificial intelligence system which adapts processing parameters to match the measured parameters of a sample to a desired profile.

The operation of the vacuum system and microwave generation system may be paused to allow access to the chamber. For example, a second food sample with a reduced processing time requirement may be added or removed from the chamber part way through the process cycle. Alternatively, food samples may be moved around in the chamber manually as a processing operation is paused and the chamber door opened (or by mechanical means with the door still closed, whilst the microwave power is still applied or with it turned off), so the food samples experience the different electromagnetic fields generated in different areas of the chamber. The controller or a HMI may be configured to instruct the user of how food samples should be added, removed or moved around for the most effective or desired processing.

Operation of the vacuum system 1002, operation of the microwave generation system 1003, and the measurement informed control of these systems 1004 may continue or be repeated until the food sample has been processed as required. The various elements of the system can then be turned off and the processed food sample removed 1005.

Although example embodiments have been described, these are not intended to limit the scope of the invention, which should be determined with reference to the accompanying claims.

Although discussed here primarily in relation to the drying of food, and also cooking of food, these apparatuses and techniques described herein are also useful for the processing of other materials such as organic materials commonly used in the pharmaceutical, electronics, medical device, and aerospace industries.

1-16. (canceled)

17. A microwave organic sample processing apparatus comprising:
an organic sample processing chamber;
a first microwave generator configured to generate microwave radiation having a frequency within a first frequency range;
a microwave waveguide disposed in or at the chamber configured to emit the microwave radiation from the first microwave generator into the chamber;
a second microwave generator configured to generate microwave radiation having a frequency within a second frequency range, wherein the second frequency range is lower than the first frequency range, and
an antenna disposed in or at the chamber configured to emit the microwave radiation from the second microwave generator into the chamber.

18. The apparatus of claim 17 wherein the first frequency range is 2.4-2.5 GHz and the second frequency range is 400-500 MHz.

19. The apparatus of claim 17, further comprising a vacuum system that is fluidly coupled to the chamber and operable to reduce the pressure in the chamber to less than atmospheric pressure.

20. The apparatus of claim 17, further comprising at least one sensor configured to measure the forward power and reflected power of the first microwave generator and second microwave power generator.

21. The apparatus of claim 20 wherein the apparatus is configured to send data comprising signals generated by the at least one sensor to a controller, and wherein the apparatus is further configured to receive control instructions from the controller in response.

22. The apparatus of claim 17, further comprising one or more multivariant spectroscopic sensors configured to measure spectroscopic data relating to the sample.

23. The apparatus of claim 22 wherein the spectroscopic data is analysed by a processor, wherein the processor is configured to determine one or more parameters descriptive of the
sample, wherein the one or more parameters include pH content, fat content, protein content, water content.

24. The apparatus of claim 20 wherein the apparatus is further configured to communicate with a cloud-based AI system, wherein the AI system is configured to optimise one or more recipes and/or processing profiles, and wherein the controller is configured to generate control instructions to control the generation of microwave radiation from the first microwave generator and second microwave generator in accordance with one or more optimised recipes or processing profiles.

25. The apparatus of claim 24 wherein the controller is configured to use the measurements of forward power and reflected power to calculate the amount of power consumed during processing of the organic sample.

26. The apparatus of claim 24 wherein the controller is configured to control real-time operation of the one or more microwave generators according to the control instructions.

27. The apparatus of claim 17 further comprising:
a plurality of waveguides disposed in or at the chamber,
a plurality of first microwave generators, wherein each waveguide is configured to transmit the microwave radiation from each of the plurality of first microwave generators, respectively, into the chamber, or wherein the plurality of waveguides are configured to transmit the microwave radiation from a first microwave generator into the chamber.

28-36. (canceled)

37. A system for controlling operation of a microwave sample processing apparatus, the system comprising
one or more processors for processing data;
storage for storing a plurality of processing profiles, wherein the processing profiles comprise profiles of signals from sensors in a microwave food processing system over the course of a processing cycle, wherein each of the profiles corresponds to a desired processing cycle that results in a desired processed organic sample;
a machine learning module configured to:
receive first sensor data from one or more sensors in the microwave organic sample processing apparatus, wherein the sensor data comprises data relating to characteristics of the organic sample
receive second sensor data relating to conditions within the apparatus,
process the first and second sensor data according to one or more machine learning algorithms, and output quantitative values of characteristics of the organic sample;
wherein the one or more processors is configured to
compare the quantitative values to a preselected profile, and
generate control information, wherein the control information is configured to control operation of the apparatus to converge the signals from the sensors towards the preselected profile, and
send control information to the microwave processing apparatus.

38. The system of claim 37 wherein the system is further configured to receive sample data from the apparatus relating to the quality of the sample after microwave processing, and wherein the machine learning module is configured to use the sample data to adapt a profile, train itself as to the operation of the microwave food processing system using feedback or measurements signals from sensors of the microwave food processing system;
the artificial intelligence system comprises a plurality of predetermined profiles of feedback signals from sensors of the microwave food processing system over the course of a processing cycle, wherein each of the predetermined profiles corresponds to a desired processing cycle that results in a desired processed product; and
the artificial intelligence system is configured to provide input signals to the microwave food processing system, such that the feedback signals obtained match one of the predetermined profiles of feedback signals, thereby resulting in the desired processed product.

39. The system of claim 38 wherein a profile is associated with a recipe, wherein a recipe defines parameters of radiation in the chamber required to optimal processing of particular organic samples and/or organic sample arrangements.

40-41. (canceled)

42. An antenna for emitting microwave radiation into a cavity, wherein the antenna is configured to emit microwave within a first frequency range of 400-500 MHz and a second frequency range of 2.4-2.5 GHz, wherein the antenna comprises
a cylindrical portion, wherein the length of the cylindrical portion is within a range of −8% and +14% of 1 19 mm, and wherein the outer diameter of the cylindrical portion is within a range of −8% and +14% of 60 mm; and
a frustoconical portion contiguous with the cylindrical portion, wherein the length of the frustoconical portion is within a range of −8% and +14% of 80 mm, wherein the outer diameter of the frustoconical portion tapers from a diameter within a range of −8% and +14% of 60 mm to a diameter within a range of −8% and +14% of 20 mm.

43. The antenna of claim 42, further comprising a connector portion configured for connecting the antenna to diplexer or coaxial cable, wherein the length of the connector portion is within a range of −8% and +14% of 20 mm and an outer diameter of the connector portion is within a range of −8% and +14% of 26 mm.

44. The antenna of any claim 42, wherein the first frequency range is 400-500 MHz.

45. The antenna of claim 42, wherein a first portion of the cylindrical portion is surrounded by a dielectric material, and second portion of the lower antenna region is exposed.

46. The antenna of claim 45, wherein the frustoconical portion is surrounded by a dielectric material, and the dielectric material is surrounded by a metal enclosure.

47. The antenna of claim 42, further comprising a transition region of dielectric material surrounding the antenna above the frustoconical region, wherein the dielectric material of the transition region is surrounded by a metal enclosure.
